(19) United States
(12) Patent Application Publication
(10) Pub. No.: US 2024/0391437 A1
(43) Pub. Date: Nov. 28, 2024

(54) ELECTRIC PARKING BRAKE AND CONTROL METHOD THEREOF

(71) Applicant: HL MANDO CORPORATION, Gyeonggi-do (KR)

(72) Inventors: Yutae KIM, Gyeonggi-do (KR); Sehyun KIM, Gyeonggi-do (KR)

(21) Appl. No.: 18/386,948

(22) Filed: Nov. 3, 2023

(30) Foreign Application Priority Data
May 22, 2023 (KR) 10-2023-0065895

(51) Int. Cl. B60T 8/88; B60T 8/92; B60T 13/74; B60T 17/22

(52) U.S. Cl. CPC B60T 8/885; B60T 8/92; B60T 13/74; B60T 17/22; B60T 2270/403

(57) ABSTRACT

An electric parking brake according to an embodiment includes: a brake system including a braking portion installed in a rear wheel of a vehicle and providing a friction force to the rear wheel, and an Electric Parking Brake (EPB) driving motor configured to operate the braking portion; an EPB power line configured to transfer a control signal to the EPB driving motor; a Brake Electronic Control Unit (ECU) including a first EPB control module configured to control the EPB driving motor through the EPB power line; and a redundant control unit interposed between the brake system and the Brake ECU and configured to control the EPB driving motor.

### CROSS-REFERENCE TO RELATED APPLICATION(S)

This application is based on and claims priority under 35 U.S.C. § 119 to Korean Patent Application No. 10-2023-0065895, filed on May 22, 2023, in the Korean Intellectual Property Office, the disclosure of which is incorporated by reference herein in its entirety.

### BACKGROUND

### 1. Field

The disclosure relates to an electric parking brake and a control method thereof.

### 2. Description of the Related Art

A brake system is an apparatus for decelerating and stopping a vehicle during driving and maintaining the stop state of the vehicle. The brake system includes a parking brake for decelerating and stopping the vehicle during driving and maintaining the stop state of the vehicle.

The parking brake maintains the stop states of the wheels by pulling the parking cable by the control of a lever located to one side of the driver seat inside the vehicle to provide a braking force to the wheels connected to the parking cable, and removes the braking force provided to the wheels by releasing the lever to release the parking cable.

Because the parking brake operates only by a driver's intention, the driver should control the lever whenever parking or starting driving, which has caused the driver's great inconvenience in use. For this reason, an Electric Parking Brake (EPB) system for automatically operating the parking brake by the motor according to the operation state of the vehicle has been developed.

The EPB system operates or releases the parking brake and secures braking stability for emergency situations by a driver's manual control mode and automatically in conjunction with a Hydraulic Electronic Control Unit (HECU), an engine Electronic Control Unit (ECU), a Traction Control Unit (TCU), etc. through a switch control.

The EPB system is configured by integrating an ECU, a motor, a gear, a parking cable, a braking force sensor, etc. into one body. The ECU receives related information from the HECU, ECU, TCU, etc. through a Controller Area Network (CAN), understands a driver's intention, and then drives the motor. Then, the motor is driven to operate the gear, the parking cable is pulled by the operation of the gear to provide a braking force to the wheels, and accordingly, the vehicle is maintained in a stable state.

### SUMMARY

It is an aspect of the disclosure to provide an Electric Parking Brake (EPB) that is controllable by a Brake Electronic Control Unit (ECU) and a Redundant unit.

It is an aspect of the disclosure to provide an Electric Parking Brake (EPB) that monitors an EPB power line and switches the EPB power line when the EPB is not driven in response to an EPB driving signal to cause an Redundant unit to perform an EPB function.

Additional aspects of the disclosure will be set forth in part in the description which follows and, in part, will be obvious from the description, or may be learned by practice of the disclosure.

In accordance with an aspect of the disclosure, an electric parking brake includes: a brake system including a braking portion installed in a rear wheel of a vehicle and providing a friction force to the rear wheel, and an Electric Parking Brake (EPB) driving motor configured to operate the braking portion; an EPB power line configured to transfer a control signal to the EPB driving motor; a Brake Electronic Control Unit (ECU) including a first EPB control module configured to control the EPB driving motor through the EPB power line; and a redundant control unit interposed between the brake system and the Brake ECU and configured to control the EPB driving motor.

The redundant control unit may be configured to monitor a connection state between the Brake ECU and the EPB driving motor in real time through the EPB power line.

The redundant control unit may be configured to directly control the EPB driving motor when the first EPB control module fails to control the EPB driving motor.

The redundant control unit may be configured to disconnect the Brake ECU from the EPB driving motor on the EPB power line and connect to the EPB driving motor.

The redundant control unit may include: a switch configured to switch the EPB power line; and a second EPB control module to control the EPB driving motor.

The redundant control unit may further include: a monitoring device connected to the EPB power line; a communicator configured to receive an EPB driving signal transmitted from outside; and a redundant integrated controller to which the monitoring device and the communicator are connected.

The monitoring device may be configured to monitor a state of the EPB driving motor through the EPB power line.

The redundant integrated controller may be configured to operate the switch to switch the EPB power line from the first EPB control module to the second EPB control module.

The redundant integrated controller may be configured to issue a command for operating the EPB driving motor to the second EPB control module.

In a normal mode, the EPB power line may be configured to connect the first EPB control module to the EPB driving motor, and in a redundant mode, the EPB power line may be configured to connect the second EPB control module to the EPB driving motor.

The redundant integrated controller may be configured to operate the switch only when a signal indicating that the first EPB control module is in an abnormal state is received from the monitoring device.

The EPB power line may include a first power line configured to improve a braking force of the brake system, and a second power line configured to reduce a braking force of the brake system, and the switch may include a first switch configured to switch the first power line, and a second switch configured to switch the second power line.

The EPB power line may be divided into an ECU portion connecting the Brake ECU to the redundant control unit, and a redundant portion connecting the redundant control unit to the EPB driving motor.

In accordance with an aspect of the disclosure, a method for controlling an electric parking brake includes: at a redundant control unit, detecting an input of an Electric Parking Brake (EPB) driving signal through a communication line; at the redundant control unit, monitoring an EPB power line connecting the Brake Electronic Control Unit (ECU) to an EPB driving motor of a brake system; at the redundant control unit, operating a switch when the EPB driving motor fails to operate; and at the redundant control unit, operating the EPB driving motor.

The EPB driving signal may be a signal instructing a second EPB control module of the redundant control unit to operate the EPB driving motor.

The operating of the switch may include: at a redundant integrated controller of the redundant control unit, issuing a command for switching the EPB power line to the switch; at the switch, disconnecting the Brake ECU from the EPB driving motor; and at the switch, connecting a second EPB control module of the redundant control unit to the EPB driving motor.

The operating of the EPB driving motor may include: at the redundant integrated controller, issuing an EPB driving command to the second EPB control module; and at the second EPB control module, operating the EPB driving motor.

The redundant integrated controller may be configured to operate the switch by the EPB driving signal.

The redundant control unit may be configured to operate the switch to switch a connection of the EPB power line from a normal mode to a redundant mode.

The method may further include, before detecting the input, at a first EPB control module of the Brake ECU, operating the EPB driving motor.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram showing an electric parking brake according to an existing technique;

FIG. 2 is a block diagram showing a normal operation state of an electric parking brake according to an embodiment of the disclosure;

FIG. 3 is a block diagram showing an abnormal operation state of an electric parking brake according to an embodiment of the disclosure;

FIG. 4 is a block diagram for describing a detailed configuration of an electric parking brake according to an embodiment of the disclosure;

FIG. 5 is a flowchart for describing a method for controlling an electric parking brake according to an embodiment of the disclosure;

FIG. 6 is a flowchart for describing a method for controlling the electric parking brake shown in FIG. 4;

FIG. 7 is a flowchart for describing a detailed process of an operation of operating a switch in FIG. 5; and

FIG. 8 is a flowchart for describing a detailed process of an operation of operating an Electric Parking Brake (EPB) driving motor in FIG. 5.

### DETAILED DESCRIPTION

Hereinafter, embodiments of the disclosure will be described in detail with reference to the accompanying drawings. The following embodiments are provided to transfer the concepts of the disclosure to one of ordinary skill in the technical art to which the disclosure belongs. However, the disclosure is not limited to these embodiments, and may be embodied in another form. In the drawings, parts that are irrelevant to the descriptions may be not shown in order to clarify the disclosure, and also, for easy understanding, the sizes of components are more or less exaggeratedly shown.

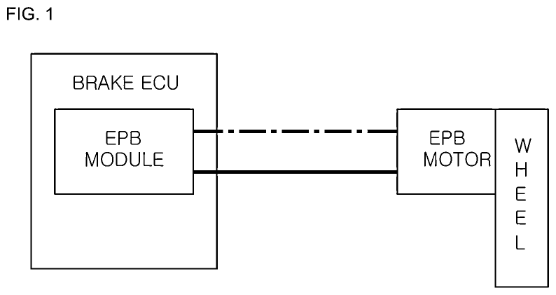

FIG. 1 is a block diagram showing an electric parking brake (EPB) according to an existing technique.

In an electric parking brake, an Electronic Control Unit (ECU) that is in charge of EPB functions may apply a braking force by driving a motor installed in a wheel. At this time, to increase/decrease the braking force by an electrical control, the ECU that is in charge of the EPB functions may apply current in both directions.

As the major trend of vehicles changes from internal combustion engine vehicles to electric vehicles, a P stage function previously performed in a transmission may operate in an EPB. However, in a system shown in FIG. 1, when a Brake ECU for controlling an EPB motor breaks down, parking may become impossible while a vehicle stops.

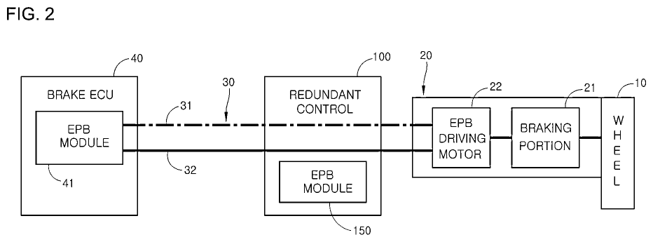

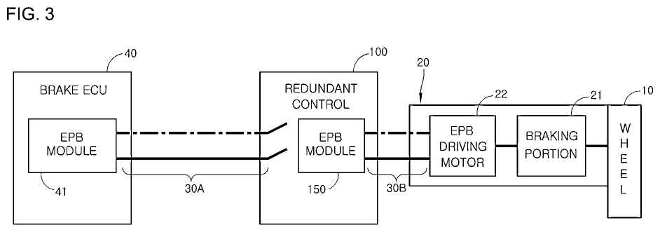

FIGS. 2 and 3 are block diagrams showing operation states of an electric parking brake 1 according to an embodiment of the disclosure. FIG. 2 shows a normal mode as a normal state, and FIG. 3 shows a redundant mode as an abnormal state.

Referring to FIGS. 2 and 3, the electric parking brake 1 may include a brake system 20 including a braking portion 21 installed in a rear wheel 10 of a vehicle and providing a friction force to the rear wheel 10 and an EPB driving motor 22 for operating the braking portion 21, an EPB power line 30 for transferring a control signal to the EPB driving motor 22, a brake ECU 40 including a first EPB control module 41 configured to control the EPB driving motor 22 through the EPB power line 30, and a redundant control unit 100 interposed between the brake system 20 and the brake ECU 40 and configured to control the EPB driving motor 22.

The EPB power line 30 may be divided into an ECU portion 30A connecting the Brake ECU 40 to the redundant control unit 100, and a redundant portion 30B connecting the redundant control unit 100 to the EPB driving motor 22. Also, the EPB power line 30 may include a first power line 31 for improving a braking force of the brake system 20, and a second power line 32 for reducing a braking force of the brake system 20.

The redundant control unit 100 may monitor a connection state between the Brake ECU 40 and the EPB driving motor 22 in real time through the EPB power line 30. That is, the redundant control unit 100 may identify whether signal transmission by the EPB power line 30 fails or succeeds, or identify whether or not the EPB driving motor 22 operates according to a command of the signal although the signal transmission succeeds.

Referring to FIG. 2, in the normal mode, the brake ECU 40 may control the EPB driving motor 22 by bypassing the redundant control unit 100.

Referring to FIG. 3, when the first EPB control module 41 fails to control the EPB driving motor 22, the redundant control unit 100 may itself control the EPB driving motor 22. The redundant control unit 100 may disconnect the brake ECU 40 from the EPB driving motor 22 on the EPB power line 30, and directly connect to the EPB driving motor 22.

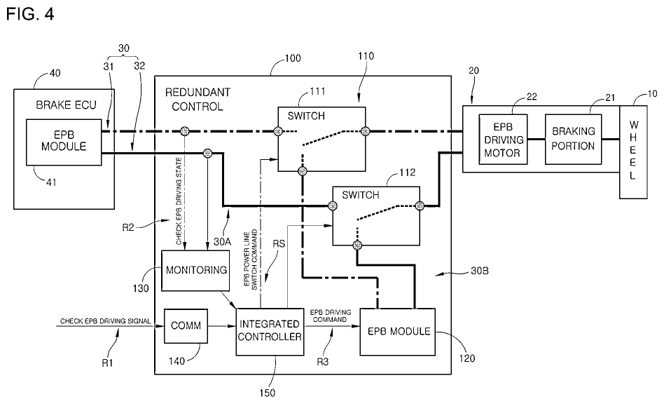

FIG. 4 is a block diagram for describing a detailed configuration of the electric parking brake 1 according to an embodiment of the disclosure.

The redundant control unit 100 may further include a switch 110 configured to switch the EPB power line 30, a second EPB control module 120 configured to control the EPB driving motor 22, a monitoring device 130 connected to the EPB power line 30, a communicator 140 configured to receive an EPB driving signal AS transmitted from outside, and a redundant integrated controller 150 to which the monitoring device 130 and the communicator 140 are connected.

The switch 110 may include a first switch 111 configured to switch the first power line 31, and a second switch 112 configured to switch the second power line 32. The first switch 111 and the second switch 112 may operate simultaneously by the redundant integrated controller 150.

The redundant control unit 100 may operate the switch 110 to switch a connection of the EPB power line 30 from the normal mode to the redundant mode. In the normal mode, the EPB power line 30 may connect the first EPB control module 41 to the EPB driving motor 22. In the redundant mode, the EPB power line 30 may connect the second EPB control module 120 to the EPB driving motor 22.

As denoted by an arrow RS, the redundant integrated controller 150 may operate the switch 110 only when a signal indicating that the first EPB control module 41 is in an abnormal state is received from the monitoring device 130.

As denoted by an arrow R2, the monitoring device 130 may monitor a state of the EPB driving motor 22 through the EPB power line 30. The monitoring device 130 may transmit a result of identification on the state of the EPB driving motor 22 to the redundant integrated controller 150.

As denoted by the arrow RS, the redundant integrated controller 150 may issue an EPB power line switch command to the switch 110. The redundant integrated controller 150 may operate the switch 110 to switch the EPB power line 30 from the first EPB control module 41 to the second EPB control module 120.

As denoted by an arrow R3, the redundant integrated controller 150 may issue a command for operating the EPB driving motor 22 to the second EPB control module 120. After the switch 110 operates, the first EPB control module 41 may no longer control the EPB driving motor 22, and the second EPB control module 120 may control the EPB driving motor 22.

According to an embodiment, in a section where the first EPB control module 41 operates normally, the redundant control unit 100 may not influence a current operation. However, while the first EPB control module 41 operates abnormally, the first EPB control module 41 may be prevented from being involved in driving the EPB driving motor 22, and the second EPB control module 120 may control an operation of the EPB driving motor 22.

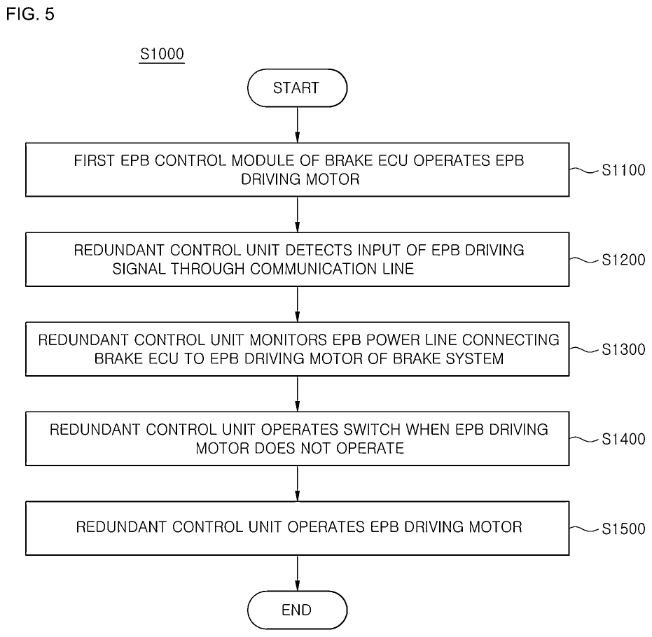

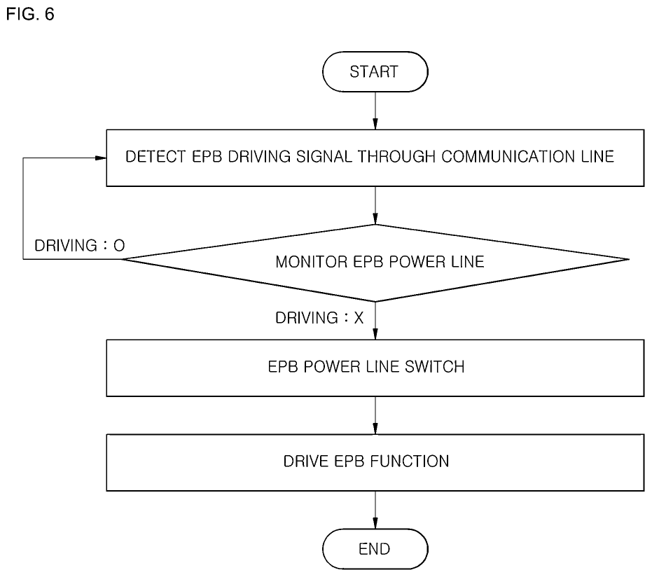

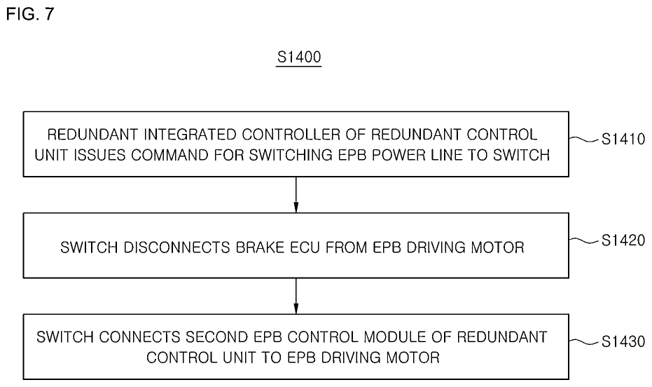

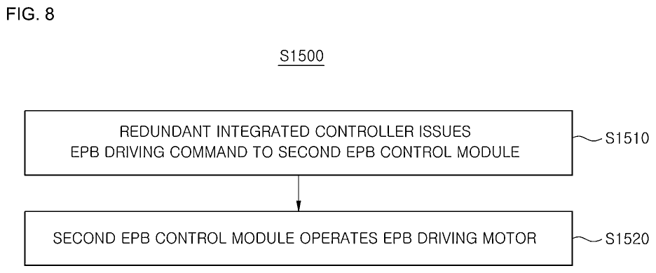

FIG. 5 is a flowchart for describing a method S1000 for controlling an electric parking brake according to an embodiment of the disclosure. FIG. 6 is a flowchart for describing a method for controlling the electric parking brake shown in FIG. 4. FIG. 7 is a flowchart for describing a detailed process of an operation S1400 of operating a switch in FIG. 5. FIG. 8 is a flowchart for describing a detailed process of an operation S1500 of operating an EPB driving motor in FIG. 5.

Description about the electric parking brake 100, overlapping that in the embodiment described above will be omitted.

The method S1000 for controlling the electric parking brake may include an operation S1100 in which the first EPB control module 41 of the brake ECU 40 operates the EPB driving motor 22, an operation S1200 in which the redundant control unit 100 detects an input of an EPB driving signal through a communication line, an operation S1300 in which the redundant control unit 100 monitors the EPB power line 30 connecting the Brake ECU 40 to the EPB driving motor 22, an operation S1400 in which the redundant control unit 100 operates the switch 110 when the EPB driving motor 22 does not operate, and an operation S1500 in which the redundant control unit 100 operates the EPB driving motor 22.

Herein, the EPB driving signal may be a signal instructing the second EPB control module 120 of the redundant control unit 100 to operate the EPB driving motor 22. The redundant integrated controller 150 may operate the switch 110 according to the EPB driving signal.

Referring to FIG. 7, the operation S1400 of operating the switch 110 may include an operation S1410 in which the redundant integrated controller 150 issues a command for switching the EPB power line 30 to the switch 110, an operation S1420 in which the switch 110 disconnects the Brake ECU 40 from the EPB driving motor 22, and an operation S1430 in which the switch 110 connects the second EPB control module 120 of the redundant control unit 100 to the EPB driving motor 22.

Referring to FIG. 8, the operation S1500 of operating the EPB driving motor 22 may include an operation S1510 in which the redundant integrated controller 150 issues an EPB driving command to the second EPB control module 120, and an operation S1520 in which the second EPB control module 120 operates the EPB driving motor 22.

Referring to FIG. 6, the method S1000 for controlling the electric parking brake according to an embodiment may be again executed sequentially from the operation S1200 of detecting an input, when the EPB driving motor 22 operates normally in the operation S1300 of monitoring.

According to an embodiment, a problem that is generated when the ECU for operating the EPB driving motor breaks down may be resolved. Also, an autonomous vehicle may perform a braking function when stopping through the EPB driving motor.

Because the electric parking brake according to the current embodiment controls the EPB motor by the redundant control unit, a locked state of the parking brake may be released even when the Brake ECU breaks down.

In the method for controlling the electric parking brake according to the current embodiment, because the redundant control unit monitors the EPB power line in real time, parking may become possible while the vehicle stops in an autonomous driving system.

So far, although the disclosure has been described by the limited embodiments and drawings, the disclosure is not limited to these, and various corrections and modifications can be made by one of ordinary skill in the technical art to which the disclosure belongs within the technical concepts of the disclosure and equivalents of the appended claims.

What is claimed is:

1. An electric parking brake comprising:
a brake system including a braking portion installed in a rear wheel of a vehicle and providing a friction force to the rear wheel, and an Electric Parking Brake (EPB) driving motor configured to operate the braking portion;
an EPB power line configured to transfer a control signal to the EPB driving motor;
a Brake Electronic Control Unit (ECU) including a first EPB control module configured to control the EPB driving motor through the EPB power line; and
a redundant control unit interposed between the brake system and the Brake ECU and configured to control the EPB driving motor.

2. The electric parking brake of claim 1, wherein the redundant control unit is configured to monitor a connection state between the Brake ECU and the EPB driving motor in real time through the EPB power line.

3. The electric parking brake of claim 1, wherein the redundant control unit is configured to directly control the EPB driving motor when the first EPB control module fails to control the EPB driving motor.

4. The electric parking brake of claim 2, wherein the redundant control unit is configured to disconnect the Brake ECU from the EPB driving motor on the EPB power line and connect to the EPB driving motor.

5. The electric parking brake of claim 1, wherein the redundant control unit includes:
a switch configured to switch the EPB power line; and
a second EPB control module to control the EPB driving motor.

6. The electric parking brake of claim 5, wherein the redundant control unit further includes:
a monitoring device connected to the EPB power line;
a communicator configured to receive an EPB driving signal transmitted from outside; and
a redundant integrated controller to which the monitoring device and the communicator are connected.

7. The electric parking brake of claim 6, wherein the monitoring device is configured to monitor a state of the EPB driving motor through the EPB power line.

8. The electric parking brake of claim 6, wherein the redundant integrated controller is configured to operate the switch to switch the EPB power line from the first EPB control module to the second EPB control module.

9. The electric parking brake of claim 8, wherein the redundant integrated controller is configured to issue a command for operating the EPB driving motor to the second EPB control module.

10. The electric parking brake of claim 8, wherein, in a normal mode, the EPB power line is configured to connect the first EPB control module to the EPB driving motor, and
in a redundant mode, the EPB power line is configured to connect the second EPB control module to the EPB driving motor.

11. The electric parking brake of claim 8, wherein the redundant integrated controller is configured to operate the switch only when a signal indicating that the first EPB control module is in an abnormal state is received from the monitoring device.

12. The electric parking brake of claim 5, wherein
the EPB power line includes a first power line configured to improve a braking force of the brake system, and a second power line configured to reduce a braking force of the brake system, and
the switch include a first switch configured to switch the first power line, and a second switch configured to switch the second power line.

13. The electric parking brake of claim 1, wherein the EPB power line is divided into an ECU portion connecting the Brake ECU to the redundant control unit, and a redundant portion connecting the redundant control unit to the EPB driving motor.

14. A method for controlling an electric parking brake, comprising:
at a redundant control unit, detecting an input of an Electric Parking Brake (EPB) driving signal through a communication line;
at the redundant control unit, monitoring an EPB power line connecting the Brake Electronic Control Unit (ECU) to an EPB driving motor of a brake system;
at the redundant control unit, operating a switch when the EPB driving motor fails to operate; and
at the redundant control unit, operating the EPB driving motor.

15. The method of claim 14, wherein the EPB driving signal is a signal instructing a second EPB control module of the redundant control unit to operate the EPB driving motor.

16. The method of claim 14, wherein the operating of the switch includes:
at a redundant integrated controller of the redundant control unit, issuing a command for switching the EPB power line to the switch;
at the switch, disconnecting the Brake ECU from the EPB driving motor; and
at the switch, connecting a second EPB control module of the redundant control unit to the EPB driving motor.

17. The method of claim 16, wherein the operating of the EPB driving motor includes:
at the redundant integrated controller, issuing an EPB driving command to the second EPB control module; and
at the second EPB control module, operating the EPB driving motor.

18. The method of claim 16, wherein the redundant integrated controller is configured to operate the switch by the EPB driving signal.

19. The method of claim 14, wherein the redundant control unit is configured to operate the switch to switch a connection of the EPB power line from a normal mode to a redundant mode.

20. The method of claim 14, further comprising, before detecting the input, at a first EPB control module of the Brake ECU, operating the EPB driving motor.
